(19) United States
(12) Patent Application Publication
(10) Pub. No.: US 2025/0241475 A1
(43) Pub. Date: Jul. 31, 2025

(54) COFFEE BREWING SYSTEM AND METHOD OF BREWING COFFEE

(71) Applicant: Imam Abdulrahman Bin Faisal University, Dammam (SA)

(72) Inventors: Layan ALOTHMAN, Dammam (SA); Noran KATTAN, Dammam (SA); Danah ALHUSAIN, Dammam (SA); Nora ALHUMAIDI, Dammam (SA); Amjad ALSHEHRI, Dammam (SA); Doaa Saleh ALLSHUREIH, Dammam (SA)

(73) Assignee: Imam Abdulrahman Bin Faisal University, Dammam (SA)

(21) Appl. No.: 18/428,121

(22) Filed: Jan. 31, 2024

(51) Int. Cl. A47J 31/42; A23F 5/04; A23F 5/08; A23F 5/26; A47J 31/18; A47J 31/44; A47J 31/52; A47J 42/06; A47J 42/50; A47J 42/52

(52) U.S. Cl. CPC A47J 31/42; A23F 5/04; A23F 5/08; A23F 5/26; A47J 31/18; A47J 31/4439; A47J 31/525; A47J 42/06; A47J 42/50; A47J 42/52

(57) ABSTRACT

A coffee brewing system and a method of brewing coffee are provided. The coffee brewing system comprises a base stand, an interactive display screen integral with the base stand, a coffee bean roaster, a coffee bean grinder, and a coffee brew chamber. The coffee bean roaster is a horizontally mounted cylinder with helical mixing blades and an electric heat system on a lower surface, which is detachably mounted to the base stand. The coffee bean grinder is a vertically orientated burr grinder and is detachably mounted to the base stand. The coffee bean grinder is positioned below the coffee bean roaster and configured to receive roasted coffee beans exiting the flap of the coffee bean roaster. The coffee brew chamber is detachably mounted to a heating base integral with the base stand.

### BACKGROUND

### Technical Field

The present disclosure is directed to beverage preparation systems and methods, and more specifically to a coffee brewing system and a method of brewing coffee which integrate coffee bean roasting, grinding, and brewing functionalities.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present disclosure.

For coffee brewing, the current state of the art provides a variety of methods and devices, each dedicated to specific phases of coffee preparation: roasting, grinding, and brewing. The focus has traditionally been on different equipment for each of these specific phases. Technological advancements in these areas have led to a variety of innovations. For instance, roasters have evolved to offer varying degrees of heat control and mixing capabilities, while grinders have seen improvements in achieving consistent grind sizes; however, these advancements often exist in isolation, leading to a disjointed coffee preparation process. This lack of integration results in inconsistencies in the final product.

The technical problems in existing coffee preparation systems include uneven roasting, inconsistent grinding, and suboptimal brewing conditions. Uneven roasting is often a result of inadequate heat distribution or ineffective bean agitation within the roaster. Inconsistent grinding can be attributed to the limitations of grinder design, which may not always achieve the desired uniformity for optimal coffee extraction. Brewing, which depends heavily on precise temperature and timing, suffers when not seamlessly integrated with the preceding steps. These issues arise due to the absence of a unified mechanism that can synchronize the different temperatures and timings of each phase.

Solutions to related problems have been proposed. For instance, US Patent Publication No. 20180008088A1 discloses a coffee maker and brewing method based on coffee color. This reference provides a dual roaster setup and a funnel for passing different coffee bean quantities and incorporates a grinder and a brewing container, with a color panel for selecting coffee color, influencing roasting temperatures. This reference, however, does not integrate a horizontally mounted cylinder roaster with helical mixing blades and an electric heat system, a vertically oriented burr grinder, and a detachable brewing chamber with an interactive display screen for real-time control.

U.S. Pat. No. 4,895,308A discloses a fully automatic coffee maker that has a roasting portion which heats raw coffee beans placed therein, a grinding portion which grinds the roasted coffee beans, a transferring portion which is connected between the roasting portion and the grinding portion and automatically transfers the roasted coffee beans from the roasting portion to the grinding portion, and an extracting portion which extracts the coffee from the ground coffee beans loaded therein. This reference, however, does not integrate a horizontally mounted cylinder roaster with helical mixing blades and an electric heat system, a vertically oriented burr grinder, and a detachable brewing chamber with an interactive display screen for real-time control.

CN 112773195A discloses a bean grinding coffee machine with an integrated brewing chamber and water tank and a stuffy steaming grinding control method and includes a coffee cup placement cavity and utilizes a motor-connected grinding cutter set. This reference, however, does not integrate a horizontally mounted cylinder roaster with helical mixing blades and an electric heat system, a vertically oriented burr grinder, and a detachable brewing chamber with an interactive display screen for real-time control.

Each of the aforementioned references suffers from one or more drawbacks hindering their adoption. Accordingly, it is an objective of the present disclosure to provide a solution that offer a comprehensive integration of coffee preparation phases, to ensure a seamless transition from roasting to grinding to brewing, all within a single, environmentally efficient unit.

### SUMMARY

In an exemplary embodiment, a coffee brewing system is provided. The coffee brewing system comprises a base stand having a flat horizontal section, a vertical section circumferentially connected to an edge of the flat horizontal section, and an interactive display screen integral with the base stand. The coffee brewing system further comprises a coffee bean roaster mounted on the vertical section of the base stand. Herein, the coffee bean roaster is a horizontally mounted cylinder with helical mixing blades. Further, herein the coffee bean roaster has an electric heat system on a lower surface and a flap on a front surface. Further, herein the coffee bean roaster is detachably mounted on the vertical section of the base stand. The coffee brewing system further comprises a coffee bean grinder. Herein, the coffee bean grinder is a vertically orientated burr grinder detachably mounted on the flat horizontal section of the base stand. Further, herein the coffee bean grinder is positioned below the flap on the front surface of the coffee bean roaster and configured to receive roasted coffee beans exiting the flap of the coffee bean roaster. The coffee brewing system further comprises a coffee brew chamber. Herein, the coffee brew chamber is detachably mounted to a heating base integral with the flat horizontal section of the base stand.

In some embodiments, the coffee brew chamber is a dallah. In some exemplary embodiments, the dallah is made of copper.

In some embodiments, the coffee bean roaster has a sensor. In some exemplary embodiments, the sensor is a temperature sensor. In some exemplary embodiments, the temperature sensor detects the temperature inside the coffee bean roaster and is connected with the electric heat system and configured to prevent coffee beans from being burned during roasting.

In some embodiments, the coffee brew chamber has a sensor. In some exemplary embodiments, the sensor is an overflow sensor. In some exemplary embodiments, the overflow sensor detects a liquid in the coffee brew chamber and is connected with the heating base and configured to prevent the liquid from spilling from the coffee brew chamber during brewing.

In some embodiments, the helical mixing blades are connected to a motor configured to rotate the helical mixing blades along a central axis.

In some embodiments, the horizontally mounted cylinder is made of a glass.

In some embodiments, the coffee bean grinder is made of copper.

In some embodiments, the heating base comprises a resistive heating element configured to operate at a temperature of 20 to 120° C.

In some embodiments, the flap on the front surface of the coffee bean roaster has a handle.

In some embodiments, the flat horizontal section of the base stand is circular, and the vertical section of the base stand has a front side and a rear side, wherein the front side is lower than the rear side.

In some embodiments, the interactive display screen is on the vertical section of the base stand on the front side.

In another exemplary embodiment, a method of brewing coffee is provided. The method comprises adding raw coffee bean into the coffee bean roaster of the aforementioned system. The method further comprises selecting a brew method from the interactive display screen. The method further comprises roasting the raw coffee beans to form roasted coffee beans. The method further comprises dropping the roasted coffee beans into the coffee bean grinder. The method further comprises grinding the roasted coffee beans to form ground roasted coffee beans. The method further comprises transferring the ground roasted coffee beans into the coffee brew chamber. The method further comprises adding water to the coffee brew chamber. The method further comprises heating the ground roasted coffee beans and water in the coffee brew chamber to a temperature for a time sufficient to make the coffee.

In some embodiments, roasting the raw coffee beans comprises simultaneously heating the electric heat system and rotating the helical mixing blades.

In some embodiments, heating the ground roasted coffee beans and water occurs for 5 to 30 minutes.

In some embodiments, the method of brewing coffee is a Saudi Arabian method of brewing coffee.

These and other aspects of non-limiting embodiments of the present disclosure will become apparent to those skilled in the art upon review of the following description of specific non-limiting embodiments of the disclosure in conjunction with the accompanying drawings. The foregoing general description of the illustrative present disclosure and the following detailed description thereof are merely exemplary aspects of the teachings of this disclosure and are not restrictive.

### BRIEF DESCRIPTION OF THE DRAWINGS

A more complete appreciation of the present disclosure (including alternatives and/or variations thereof) and many of the attendant advantages thereof will be readily obtained as the same becomes better understood by reference to the following detailed description of the embodiments when considered in connection with the accompanying drawings, wherein:

FIG. 1 is an exemplary perspective view diagram of a coffee brewing system, according to certain embodiments;

FIG. 2 is an exemplary front view diagram of the coffee brewing system, according to certain embodiments;

FIG. 3 is an exemplary side view diagram of the coffee brewing system, according to certain embodiments;

FIG. 4 is an exemplary top view diagram of the coffee brewing system, according to certain embodiments;

FIG. 5 is an exemplary exploded view diagram of the coffee brewing system, according to certain embodiments;

FIG. 6 is an exemplary partial diagram of the coffee brewing system depicting details of a coffee bean roaster therein, according to certain embodiments;

FIG. 7 is an exemplary partial diagram of the coffee brewing system depicting receiving of roasted coffee beans by a coffee bean grinder positioned below the coffee bean roaster, according to certain embodiments;

FIG. 8 is an exemplary perspective view diagram of the coffee bean grinder, according to certain embodiments;

FIG. 9 is an exemplary flowchart of a method of brewing coffee, according to certain embodiments;

FIG. 10 is an illustration of a non-limiting example of details of computing hardware used in the computing system, according to certain embodiments;

FIG. 11 is an exemplary schematic diagram of a data processing system used within the computing system, according to certain embodiments;

FIG. 12 is an exemplary schematic diagram of a processor used with the computing system, according to certain embodiments; and

FIG. 13 is an illustration of a non-limiting example of distributed components which may share processing with the controller, according to certain embodiments.

### DETAILED DESCRIPTION

In the following description, it is understood that other embodiments may be utilized, and structural and operational changes may be made without departure from the scope of the present embodiments disclosed herein.

Reference will now be made in detail to specific embodiments or features, examples of which are illustrated in the accompanying drawings. Whenever possible, corresponding or similar reference numbers will be used throughout the drawings to refer to the same or corresponding parts. Moreover, references to various elements described herein are made collectively or individually when there may be more than one element of the same type. However, such references are merely exemplary in nature. It may be noted that any reference to elements in the singular may also be constructed to relate to the plural and vice-versa without limiting the scope of the disclosure to the exact number or type of such elements unless set forth explicitly in the appended claims. Further, as used herein, the words “a,” “an,” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of the present disclosure are directed to a coffee brewing system and a method of brewing coffee using thereof, which integrates roasting, grinding, and brewing phases of coffee preparation. The coffee brewing system integrates multiple phases involved in coffee preparation into a unified, automated apparatus and process. The coffee brewing system and the method of the present disclosure are designed to optimize the quality and consistency of the brewed coffee, leveraging advanced technology to enhance user control and convenience. By integrating multiple phases of the coffee making process, the present disclosure addresses common inefficiencies and inconsistencies associated with traditional methods, offering a streamlined and environmentally friendly approach to coffee making.

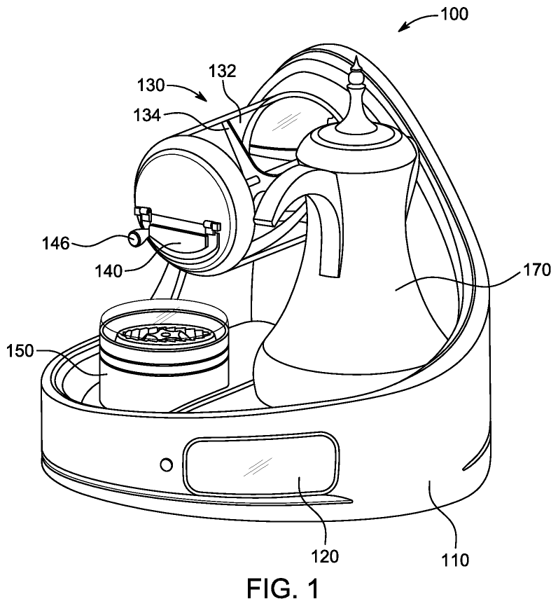

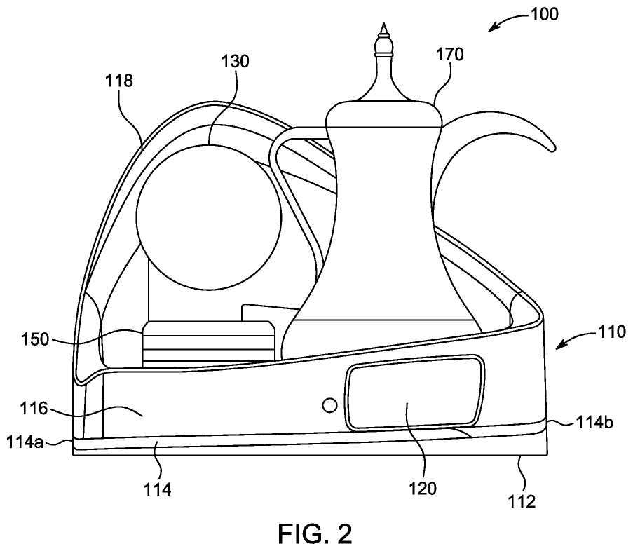

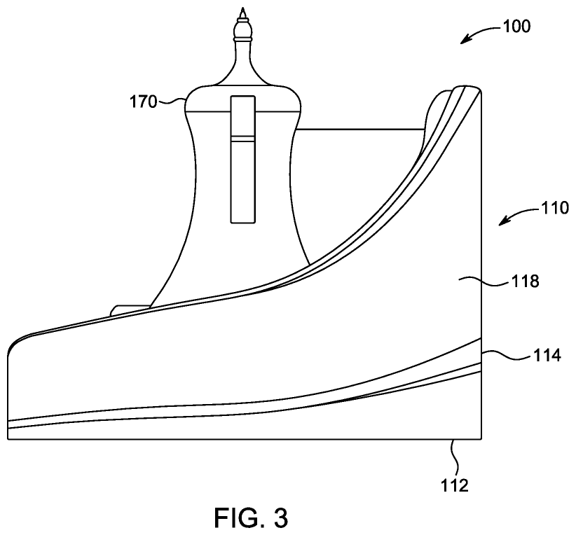

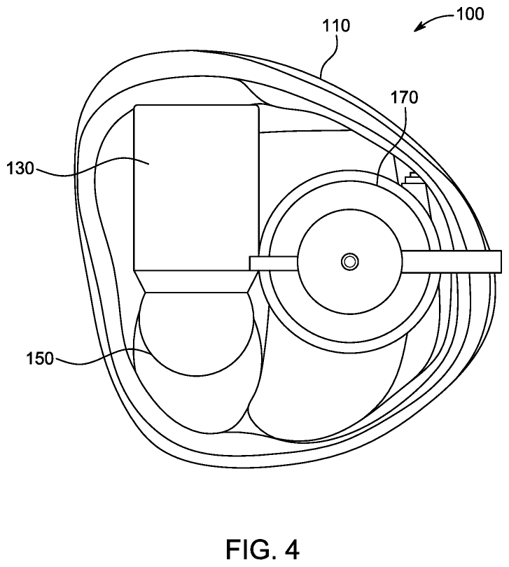

Referring to FIGS. 1-5, in combination, illustrated are different views of a coffee brewing system (as represented by reference numeral 100) of the present disclosure. The coffee brewing system 100, through its modular design and integration of functionalities, offers a comprehensive solution for coffee enthusiasts and professionals alike. The coffee brewing system 100 provides a holistic approach to coffee preparation, integrating multiple stages within a singular, unified apparatus. The coffee brewing system 100, with its integration of various processes, enhances the convenience of brewing coffee and ensures consistency in the quality of the final product. The coffee brewing system 100 is designed with a focus on user experience, convenience, quality, ease of use, and straightforward maintenance. The coffee brewing system 100 has a mix of traditional and modern aesthetics, while its compact design maximizes space efficiency for both home and commercial coffee preparation.

As illustrated, the coffee brewing system 100 includes a base stand 110. The base stand 110 is designed as a structural component of the coffee brewing system 100, to provide stability and support to all integrated components therein. The base stand 110 is also designed with considerations for weight distribution, stability, and vibration dampening, for precision and effectiveness of the coffee brewing process. In the present examples, the base stand 110 is constructed from high-quality, durable materials to withstand the rigors of regular use while maintaining its structural integrity and aesthetic appeal. These materials are selected not only for their strength and durability but also for their environmental impact, focusing on recyclability and minimal ecological footprint. Examples of base stand 110 materials include, but are not limited to, bronze, brass, silica, aluminum alloy 3003, aluminum alloys, copper, aluminum, metal, wood, glass, plastics, polaris, vegan leather, combinations thereof, and any material known in the art. In some examples, the base stand 110 may also include an integrated management system for power and control cables, ensuring that electrical components of coffee brewing system 100 are neatly organized and safely housed.

In an embodiment, the base stand 110 includes a circular base 112, preferably flat and horizontal, a curved side 114 lowered on a first side 114a and raised on a second side 114b, a curved back 118 raised and connected to the first side 114a and the second side 114b, and a curved front 116 lowered and connected to the first side 114a and second side 114b. The curved side 114, the curved front 116, and the curved back 118 preferably form a vertical section that is circumferentially connected to the flat horizontal section of the circular base 112 along an outer edge of the circular base 112. The circular base 112, the curved side 114, the curved front 116, and the curved back 118 are all connected. The curved side 114, the curved front 116, and the curved back 118 are all connected in a seamless fashion and attached to the circular base 112. In an embodiment, the flat horizontal section of the base stand 110 is circular, and the vertical section of the base stand 110 has a front side and a rear side, wherein the front side is lower than the rear side. In the present examples, the circular base 112 (as being referred) is shown to be substantially circular, and, in other examples, may be elliptic, oval, or oblique without departing from the spirit and the scope of the present disclosure. In some embodiments, the circular base 112 may have a distorted circular shape. In other embodiments, the circular base 112 may be square, rectangular, triangular, and any other shape known in the art. With the circular base 112, the base stand 110 provides a foundation for the stability of the coffee brewing system 100. The curved side 114 of the base stand 110 is formed with a lowered curve on one side (i.e., the first side 114a) and a raised curve on the opposite (i.e., the second side 114b), creating a profile that is both functional and visually engaging. This asymmetrical design allows for varied positioning of auxiliary components, facilitating ergonomic interaction for the user. Further, the curved back 118 of the base stand 110 is raised and meets the first side 114a and the second side 114b to form a structural support and enhances aesthetic design of the coffee brewing system 100. The curved back 118 may be asymmetrical. The curved front 116 of the base stand 110, conversely, slopes in a lowered curve, mirroring the design profile of the first side 114a and the second side 114b, and contributes to the structural integrity of the coffee brewing system 100. The curved front 116 may be asymmetrical. The curved front 116 of the base stand 110 is lowered for ergonomic interactions for the user. Such design supports the operational dynamics, while maintaining a sleek and modern appearance, for the coffee brewing system 100.

The coffee brewing system 100 also includes an interactive display screen 120 integral with the base stand 110. The interactive display screen 120 serves as a user interface for the operation and control of the coffee brewing system 100. The interactive display screen 120 is strategically positioned on the base stand 110 to provide users with convenient access to controls and settings for the coffee brewing system 100. For example, the interactive display screen 120 may be placed on the curved side 114, the curved front 116, and/or the curved back 118 of the base stand 110. In the present configuration, the interactive display screen 120 is provided on the curved front 116 of the base stand 110. In a non-limiting example, the interactive display screen 120 is adapted as a touch-sensitive interface which enables users to interact with the coffee brewing system 100 through touch gestures such as taps, swipes, and presses. In an embodiment, the interactive display screen 120 may be turned on with a push of the interactive display screen 120 and/or the push of a button not located on the interactive display screen 120. The button may be located to the right or left and/or top or bottom of the interactive display screen 120 or anywhere on the base stand 110. The interactive display screen 120 is configured to present information clearly and respond to user inputs, thereby allowing for precise control over the coffee brewing process. In particular, the interactive display screen 120 may employ a graphical user interface (GUI) that provides visual feedback and guidance throughout the coffee preparation process (via a controller or the like, as discussed later in detail). Such GUI may allow the user to access a variety of functions and settings, such as selecting the type of coffee to be brewed, adjusting roasting levels, setting grinding coarseness, programming brewing times, and the like.

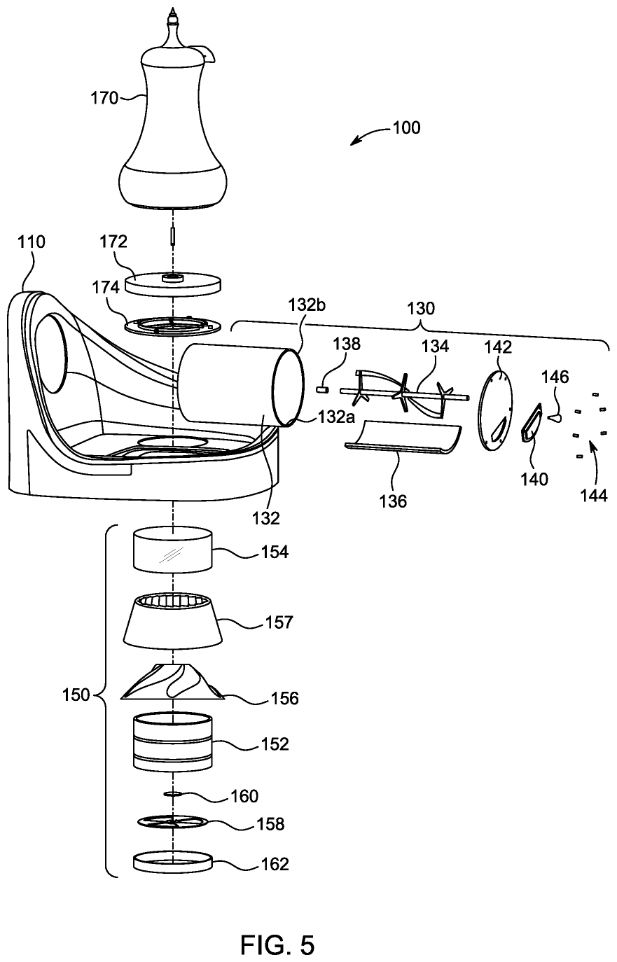

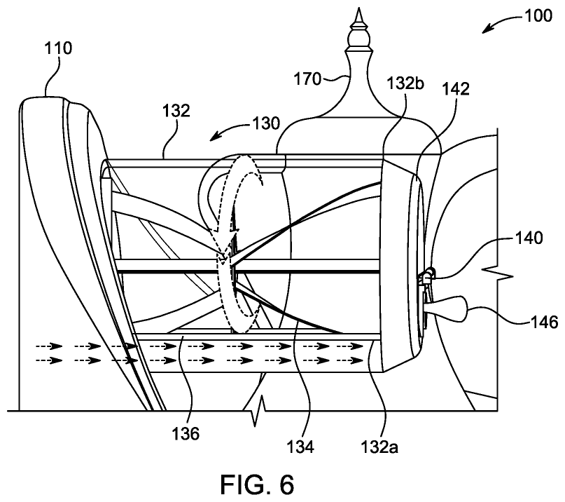

Also, as illustrated, the coffee brewing system 100 includes a coffee bean roaster 130 mounted on the vertical section of the base stand. The coffee bean roaster 130 is configured to transform raw coffee beans into roasted beans. Herein, the coffee bean roaster 130 is a horizontally mounted cylinder 132 with helical mixing blades 134. In an embodiment, the coffee bean roaster 130 may be any shape known in the art. In an example, the horizontally mounted cylinder 132 has a diameter of 80 to 100 mm, preferably 85 to 95 mm, preferably about 90 mm and a length of 120 to 160 mm, preferably 130 to 150 mm, preferably about 140 mm. The helical mixing blades 134 may be comprised of at least one blade, preferably 1 to 10 blades, preferably 2 to 6 blades, and preferably 2 to 4 blades. In some embodiments, the helical mixing blades 134 have a horizontal shaft in a center of the helical mixing blades 134 and running the length of the blades, in which the blades rotate around. The horizontal shaft may have a length of 110 to 150 mm, preferably 120 to 140 mm, preferably about 130 mm, and a diameter of 5 to 15 mm, preferably 6 to 10 mm, preferably about 8 mm. The helical mixing blades 134 may be mounted on one or more barrel vents that support the helical mixing blades 134. The one or more barrel vents have a height of 70 to 110 mm, preferably 80 to 100 mm, preferably about 90 mm. The helical mixing blades 134 may be in any shape and orientation known in the art. In an example, the helical mixing blades 134 have a height of 20 to 60 mm, preferably 30 to 50 mm, and more preferably about 40 mm and a width of 0.1 to 1 mm, preferably 0.2 to 0.8 mm, and more preferably about 0.5 mm. As shown in FIG. 5, the horizontally mounted cylinder 132 has a lower surface 132a and a front surface 132b. The coffee bean roaster 130 has an electric heat system 136 on the lower surface 132a. In an example, the electric heat system 136 has a width of 120 to 160 mm, preferably 130 to 150 mm, preferably about 138 mm and a height of 2 to 20 mm, preferably 5 to 15 mm, preferably about 10 mm. The horizontally mounted cylinder 132, with its horizontal orientation, and the helical mixing blades 134 allow for a natural tumbling action of the coffee beans, ensuring each bean is evenly exposed to heat provided by the electric heat system 136 at the lower surface 132a. Herein, the helical mixing blades 134 ensure mixing and/or stirring of coffee beans for an even roasting of the coffee beans. As shown in FIG. 6, the horizontally mounted cylinder 132 is designed to allow for the helical mixing blades 134 to rotate during operation (represented by large, dashed arrows). This motion, combined with the configuration of the helical mixing blades 134, ensures that each coffee bean receives uniform heat exposure from the electric heat system 136 and is roasted to the desired level. In a preferred embodiment, the horizontally mounted cylinder 132 is mounted to the curved back 118 of the base stand 110 and does not rotate. In some embodiments, the horizontally mounted cylinder 132 is mounted to the curved back 118 of the base stand 110 and may rotate. The helical mixing blades 134 may rotate in a clockwise or counterclockwise manner. In some embodiments, the horizontally mounted cylinder 132 may rotate in an opposite direction than the helical mixing blades. The electric heat system 136 is configured to provide a steady and controlled application of heat (represented by small, dashed arrows) for the roasting process, providing balanced temperature to roast coffee beans without burning them, thereby preserving the flavors and aromas therein. In an embodiment, the helical mixing blades 134 are connected to a motor configured to rotate the helical mixing blades 134 along a central axis. It may be understood that the helical mixing blades 134 follow a helical path centered around an axis to lift and drop the beans in a cyclical motion. This movement ensures all surfaces of the coffee beans come into contact with the heated environment, provided by the electric heat system 136, at the lower surface 132a of the horizontally mounted cylinder 132, resulting in a uniform roast without over-exposure to the heat source at any single point. In some embodiments, the helical mixing blades 134 may rotate when the electric heat system 136 is in an off position. Rotating the helical mixing blades 134 while the electric heat system is off may serve to cool the roasted coffee beans. The horizontally mounted cylinder 132 may optionally have one or more slots, vents, and the like to allow for air, heat, steam, and the like to escape before, during, and/or after the coffee beans are roasting.

Herein, the coffee bean roaster 130 roasts raw coffee beans (i.e., coffee beans of a raw state) to roasted coffee beans (i.e., coffee beans of a roasted state) with the electric heat system 136. That is, the coffee bean roaster 130 is configured to transform raw coffee beans into roasted beans for grinding and brewing. The electric heat system 136 is calibrated to provide an even and controlled application of heat across the lower surface 132a of the horizontally mounted cylinder 132, ensuring that the beans within are roasted uniformly to the desired level. The electric heat system 136 may comprises heating coils, heating strands, conductive heating methods, convective heating methods, radiation methods, any heating methods known in the art, and/or a combination thereof. Through this controlled heating mechanism, raw coffee beans are roasted, developing their flavor profiles and aromatic compounds.

In an embodiment, the horizontally mounted cylinder 132 is made of a glass. The glass for the horizontally mounted cylinder 132 is selected based on its ability to withstand high heat and temperatures needed for coffee roasting without compromising structural integrity, such that it does not crack or break under the thermal stress of repeated roasting cycles. The use of the heat-resistant glass also makes the horizontally mounted cylinder 132 transparent to provide a clear view of the coffee beans as they roast. This visibility adds to the user experience and allows the user to monitor the roasting process and make real-time adjustments based on the color and condition of the beans. In some embodiments, the horizontally mounted cylinder 132 may be constructed from other heat-resistant materials that are not glass. In some examples, the helical mixing blades 134 are also constructed from heat-resistant materials that can withstand the thermal stresses of roasting without deforming. In some embodiments, the helical mixing blades 134 are constructed from an aluminum alloy, for example, aluminum alloy 3003. In some embodiments, the electric heat system 136 is constructed from an aluminum alloy, for example, aluminum alloy 3003. In some embodiments, the helical mixing blades 134 may also comprise heating elements. Further, in some examples, the assembly of the helical mixing blades 134 and/or the electric heat system 136 to the interior of the horizontally mounted cylinder 132 is designed to ensure ease of maintenance, by allowing for the removal of the said components for cleaning or replacement.

In the present embodiments, the coffee bean roaster 130 is detachably mounted on the vertical section of the base stand 110. For this purpose, the coffee bean roaster 130 may be mounted to the base stand 110 with a detachable mounting mechanism, such as quick-release latch mechanism, twist-and-lock mechanism, magnetic coupling, hook-and-slot mechanism, and the like, without any limitations. Such detachable mounting mechanism ensures that the coffee bean roaster 130 remains firmly positioned while in use, providing both secure placement during operation and the flexibility of detachment for various purposes including loading raw coffee beans, maintenance, cleaning, and component replacement. The detachment process is made straightforward, allowing users to easily separate the coffee bean roaster 130 from the base stand 110 without the need for specialized tools or extensive technical knowledge. In some embodiments, the coffee bean roaster 130 may be permanently mounted to the base stand 110 with an opening to load raw coffee beans.

In some embodiments, the coffee bean roaster 130 has a sensor (as shown in FIG. 5 and represented by reference numeral 138). The sensor 138 is configured to be implemented to avoid coffee beans from getting burned during the roasting process, thereby ensuring the quality and consistency of the final product. In an embodiment, the sensor 138 is a temperature sensor. Herein, the temperature sensor 138 detects the temperature inside the coffee bean roaster 130 and is connected with the heating system and configured to prevent coffee beans from being burned during roasting. Specifically, the temperature sensor 138 is configured to continuously measure heat levels within the horizontally mounted cylinder 132. This real-time temperature monitoring helps to provide a feedback loop for controlling the electric heat system 136 (via a controller or the like, as discussed later in detail) to maintain optimal roasting conditions, as even minor fluctuations in temperature can impact the quality of the roasted beans. In some embodiments, the sensor 138 is a color sensor. Herein, the color sensors 138 detects the color of the coffee beans inside the coffee bean roaster 130 and prevents coffee beans from being burned. The coffee beans may be roasted to a light roast, a medium roast, a dark roast, a combination thereof, and any roast level in between. By automating the aspect of temperature control, the coffee bean roaster 130 reduces the need for constant manual monitoring, allowing users to focus on other aspects of the coffee preparation process or to engage in other activities while the beans are roasting.

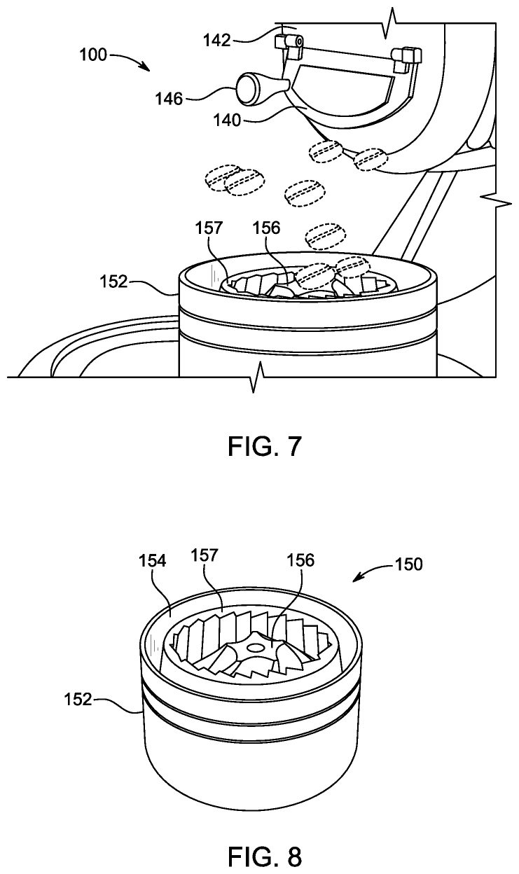

As illustrated in FIG. 7, the coffee bean roaster 130 has a flap 140 on the front surface 132b. As better illustrated in FIG. 5, the horizontally mounted cylinder 132 has a front cover 142 on the front surface 132b, onto which the flap 140 is mounted. In the coffee brewing system 100, the front cover 142 ensures a tight seal when closed to maintain the optimal roasting environment inside the horizontally mounted cylinder 132 of the coffee bean roaster 130. The flap 140 may be sealed to the front cover 142 with a magnet, a hook-and-latch system, and the like. The flap 140, positioned on the front surface 132b of the coffee bean roaster 130, specifically the horizontally mounted cylinder 132, is adapted to ensure ease of access and efficient operation. As shown, the flap 140 may be mounted on the front cover 142, which, in turn, may be mounted on the front surface 132b of the coffee bean roaster 130, by means of a hinge mechanism and fasteners (as represented by reference numeral 144), for ease of opening and closing of the flap 140. The flap 140 allows to remove the roasted coffee beans easily and safely from the horizontally mounted cylinder 132 of the coffee bean roaster 130 once the roasting process is complete. As shown, the flap 140 on the front surface 132b of the coffee bean roaster 130 has a handle 146. The handle 146 is ergonomically designed for comfort and ease of use, allowing the user to easily open the flap 140. The handle 146 ensures that users can safely interact with the coffee bean roaster 130, even when it is hot from the roasting process. In an example, the flap 140 has a height of 30 to 50 mm, preferably 35 to 45 mm, and preferably about 40 mm and a width of 70 to 90 mm, preferably 75 to 85 mm, and preferably about 80 mm, and the handle 146 has a diameter of 5 to 25 mm, preferably 10 to 20 mm, and preferably about 15 mm. Further, in some examples, the handle 146 may be provided with a vegan leather covering or the like to add to aesthetic appeal of the coffee brewing system 100.

Further, as illustrated in FIGS. 1-5, the coffee brewing system 100 includes a coffee bean grinder 150. The coffee bean grinder 150 is configured to transform roasted beans into grounds, to be made ready for brewing. Herein, as better illustrated in FIG. 7, the coffee bean grinder 150 is positioned below the flap 140 on the front surface 132b of the coffee bean roaster 130 and configured to receive roasted coffee beans exiting the flap 140 of the coffee bean roaster 130. This placement is designed for efficiency, as the roasted coffee beans exiting the flap 140 of the coffee bean roaster 130 can directly enter the coffee bean grinder 150. This arrangement minimizes the handling of roasted beans, preserving their freshness and preventing any potential spillage or wastage during the transfer from roasting phase to grinding phase. In some embodiments, the helical mixing blades 134 may rotate while the flap 140 is in an open position to assist the roasted coffee beans in exiting the flap 140 of the coffee bean roaster 130.

The coffee bean grinder 150, through its grinding mechanism, contributes to the quality of the brewed coffee. Herein, the coffee bean grinder 150 is a vertically orientated burr grinder (as better illustrated in FIG. 8). The burr grinder, as opposed to other grinding mechanisms, helps to achieve a consistent grind size which contributes to the extraction process during brewing. The vertical orientation aids in the efficient and even grinding of coffee beans, leveraging gravity to assist in the movement of beans through the coffee bean grinder 150. This design ensures that the beans are ground uniformly, providing a consistent texture for a balanced and flavorful coffee extraction.

As illustrated in FIG. 5, the coffee bean grinder 150 includes a hopper 152 to collect the roasted beans from the coffee bean roaster 130. The coffee bean grinder 150 has a cover 154 (as seen in FIG. 5) to close or shut the hopper 152 for performing or during grinding/grounding operation. The coffee bean grinder 150 further includes a conical burr 156 and a burr collar 157 for grinding the beans, supported by an electronic container 158 (seen in FIG. 5) integrating all the electronic parts, and a fastener 160 (seen in FIG. 5), in the form of a bolt, that combines a firing pin, a spring, and an extractor, all housed in a locking breechblock. In some embodiments, the electronic container 158 and the fastener 160 may comprise any materials of a coffee bean grinder known in the art. In some embodiments, the conical burr 156 is fitted in the burr collar 157. In some embodiments, the conical burr 156 is located below the burr collar 157. In some embodiments, the conical burr 156 may be a flat burr, a blade, or any other burr and/or coffee bean grinding material known in the art. In some embodiments, the burr collar 157 may have a conical shape, a cylindrical shape, a flat shape, and the like. In an example, herein, the hopper 152 has a diameter of 60 to 100 mm, preferably 70 to 90 mm, and preferably about 80 mm and a height of 40 to 80 mm, preferably 50 to 70 mm, and preferably about 60 mm, while the cover 154 has a height of 5 to 20 mm, preferably 7 to 15 mm, and preferably about 10 mm. Further, in present examples, the cover 154 may be made of silica glass, plastic, or the like, to allow for the user to see the grinding process inside the hopper 152 of the coffee bean grinder 150.

Further, herein, the coffee bean grinder 150 is detachably mounted on the flat horizontal section of the base stand 110. As shown in FIG. 5, the coffee bean grinder 150 includes a bottom cover 162 for the hopper 152 to allow for such detachable mounting. This detachable feature enhances functionality and ease of use of the coffee bean grinder 150. In some embodiments, the hopper 152 has a first section and a second section. The first section of the hopper 152 houses the conical burr 156 and burr collar 157 and the second section of the hopper 152 catches ground coffee from the roasted coffee beans. The first section of the hopper 152 is located above the second section of the hopper 152. The hopper 152 is detachably connected to the bottom cover 162. The first section of the hopper 152 is detachably connected to the second section of the hopper 152 through a twisting mechanism, a hook-and-latch mechanism, a magnet, or any other mechanism known in the art. The second section of the hopper 152 is detached from the coffee bean grinder 150 to allow for the ground coffee to be used in a coffee brewing process. In other embodiments, the bottom cover 162 for the hopper 152 catches the ground coffee from the roasted coffee beans. In other embodiments, the coffee bean grinder 150 may be removed from the base stand 110 and the bottom cover 162 for the hopper 152 may be removed from the hopper to dispense ground coffee. The detachable feature also allows for easy maintenance and cleaning, ensuring that the coffee bean grinder 150 remains in optimal condition for achieving optimal performance. The ability to detach the coffee bean grinder 150 also facilitates easy access to internal components, for repairs or replacements, thereby extending the lifespan of the coffee brewing system 100.

In some embodiments, the coffee bean grinder 150 is made of copper. In other embodiments, the coffee bean grinder 150 may be made of brass, bronze, copper alloys, or any material known in the art. In general, the construction material of the coffee bean grinder 150 is chosen with both functionality and aesthetics in mind. The coffee bean grinder 150 being made of copper is visually appealing and offers durability and corrosion resistance. The use of copper contributes to the longevity of the coffee bean grinder 150, ensuring it remains functional and visually attractive over time. Moreover, the thermal conductivity of the copper helps in maintaining the temperature during the grinding process, to preserve the flavor integrity of the coffee beans. In some examples, the copper material of the coffee bean grinder 150 may be provided with a greenish coating for glossy texture.

Furthermore, as illustrated in FIGS. 1-5, the coffee brewing system 100 includes a coffee brew chamber 170. The coffee brew chamber 170 enables the final phase of coffee preparation, where the ground coffee, transformed by preceding processes, is steeped and infused with hot water to produce the final beverage. The coffee brew chamber 170 is designed to ensure optimal brewing conditions, including maintaining the correct temperature and pressure, to extract the full spectrum of flavors and aromas from the coffee grounds. In an embodiment of the present disclosure, the coffee brew chamber 170 is a dallah. The coffee brew chamber 170 is alternatively referred to as the dallah 170. In other embodiments, the coffee brew chamber 170 may be any coffee brew container known in the art. The dallah 170 is a traditional coffee pot often seen in Middle Eastern coffee culture. The dallah 170 is central to the brewing phase of the coffee brewing system 100, merging traditional aesthetics with modern functionality. In an example, the dallah 170 has a diameter of 90 to 130 mm, preferably 100 to 120 mm, and preferably about 110 mm and a height of 270 to 310 mm, preferably 280 to 300 mm, and preferably about 290 mm. In an embodiment, the dallah 170 is made of copper. In other embodiments, the dallah 170 may be made of brass, bronze, copper alloys, or any material known in the art. The copper material is chosen for the dallah 170 due to its thermal conductivity and durability. The ability of the copper material to evenly distribute heat helps in brewing processes, extracting the full range of flavors and aromas from the coffee grounds, and ensuring that the coffee is brewed uniformly. Additionally, the use of copper adds to the aesthetic of the dallah 170, enhancing the visual appeal of the coffee brewing system 100. In some examples, similar to the coffee bean grinder 150, the copper material of the dallah 170 may be provided with a greenish coating for glossy texture.

In the present embodiments, the coffee brew chamber 170 is detachably mounted to a heating base 172 integral with the flat horizontal section of the base stand 110. This detachable feature allows for ease of serving the prepared coffee, cleaning, and maintenance, ensuring that the coffee brew chamber 170 can be kept in optimal condition for brewing. In an example, the heating base 172 has a diameter of 90 to 130 mm, preferably 100 to 120 mm, and preferably about 110 mm and a height of 10 to 30 mm, preferably 15 to 25 mm, and preferably about 20 mm. The ability to detach the coffee brew chamber 170 from the heating base 172 also facilitates the safe and convenient handling, especially the coffee brew chamber 170 is hot. Further, by integrating the heating base 172 with the base stand 110, the overall footprint of the coffee brewing system 100 is minimized, making it suitable for various settings, from home kitchens to commercial establishments.

In an embodiment, the heating base 172 comprises a resistive heating element configured to operate at a temperature of 20 to 120° C., preferably 40 to 110° C., preferably 60 to 100° C., and preferably 70 to 90° C. As shown in FIG. 5, the heating base 172 incorporates an electronic heating plate 174 for controlling the process of heating the coffee. The heating base 172 is configured to operate over such wide range of temperatures, from 20 to 120° C., preferably 40 to 110° C., preferably 60 to 100° C., and preferably 70 to 90° C., allowing for precise control over the brewing process. This range of temperature settings accommodates various brewing preferences and coffee types, from light to dark roasts, each having different brewing temperatures for optimal extraction. The electronic nature of the heating base 172 also ensures consistent heating and contributes to the energy efficiency of the coffee brewing system 100, while eliminating need for traditional heat sources like charcoal, gas, and the like, which, in turn, helps to make the coffee brewing system 100 environmentally friendly.

In some embodiments, the coffee brew chamber 170 has a sensor 176 (not pictured). Herein, the sensor 176 is an overflow sensor. The overflow sensor 176 detects a liquid in the coffee brew chamber 170 and prevents the liquid from spilling from the coffee brew chamber 170 during brewing. In particular, the overflow sensor 176 may be configured to monitor the level of liquid within the coffee brew chamber 170, and specifically to detect the presence of liquid when the liquid reaches a level that poses a risk of spilling or overflowing. Upon detecting overflowing situation, the sensor 176 initiates a response mechanism designed to prevent any spillage from the coffee brew chamber 170. This response mechanism may involve controlling the heating base 172 (via a controller or the like, as discussed later in detail) to shut-off further heating or lower the heating temperature. This mechanism ensures the safety of the operation, as spills can lead to potential hazards, especially when dealing with hot liquids. This also maintains the cleanliness and integrity of the brewing area, eliminating the need for frequent cleanups due to spills. In some embodiments, the overflow sensor 176 may be located at a bottom of the coffee brew chamber 170 such that any spilled liquid may be detected due to contact therewith; however, in other examples, the overflow sensor 176 may be located close to top of the coffee brew chamber 170 to detect liquid reaching near the top thereof, and thereby prevent any potential spilling, without any limitations.

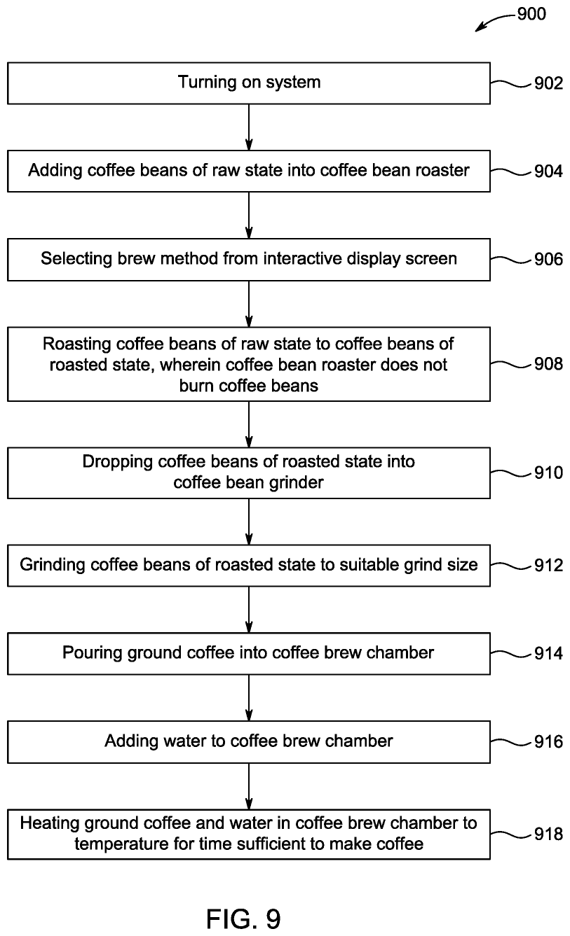

Referring to FIG. 9, the present disclosure further provides a method (as represented by a flowchart, referred by reference numeral 900) of brewing coffee. The method 900 of brewing coffee utilizes the coffee brewing system 100 (as discussed in the preceding paragraphs) and encompasses a series of steps to achieve a final product. The order in which the method 900 is described is not intended to be construed as a limitation, and any number of the described method steps can be combined in any order to implement the method 900. Additionally, individual steps may be removed or skipped from the method 900 without departing from the spirit and scope of the present disclosure.

At step 902, the method 900 may optionally include turning on the system (i.e., the coffee brewing system 100). That is, the initial step involves activating the coffee brewing system 100. This is achieved by engaging the power mechanism, typically through a user interface (such as, provided by the interactive display screen 120) or a power switch. Upon activation, the coffee brewing system 100 may initiate a start-up sequence, including a check system to ensure all components are working properly and preparing each of its components for the brewing process. At step 904, the method 900 includes adding coffee beans of a raw state into the coffee bean roaster 130. For this purpose, the user may introduce raw, unroasted coffee beans into the coffee bean roaster 130. At step 906, the method 900 includes selecting a brew method from the interactive display screen 120. That is, through the interactive display screen 120, the user selects the brewing method. Herein, the interactive display screen 120 may offer various options for roasting and brewing, allowing the user to customize the process according to their taste preferences or specific coffee bean characteristics, as well as a serving amount.

At step 908, the method 900 includes roasting the coffee beans of the raw state to coffee beans of a roasted state, wherein the coffee bean roaster 130 does not burn the coffee beans. That is, the coffee beans are then roasted within the coffee bean roaster 130, transforming them from their raw state to the roasted state. The coffee bean roaster 130 is configured to ensure that the beans are roasted evenly without burning, preserving their flavor and aroma. This may be achieved automatically by use of the sensor 138, as discussed. At step 910, the method 900 includes dropping the coffee beans of a roasted state into the coffee bean grinder 150. That is, once the roasting process is complete, the roasted coffee beans are transferred into the coffee bean grinder 150. This transition is facilitated by the user opening the flap 140 and ensuring that the cover 154 of the coffee bean grinder 150 is removed, to allow the beans to be dropped by gravity from the coffee bean roaster 130 to the coffee bean grinder 150.

At step 912, the method 900 includes grinding the coffee beans of the roasted state to a suitable grind size (i.e., ground roasted coffee beans). For this purpose, the coffee bean grinder 150 is implemented to process the roasted beans, grinding them to the suitable grind size for brewing by controlling duration and/or power of grinding therein. Herein, the user may first place the cover 154 of the coffee bean grinder 150 back on. It may be noted that the granularity of the grind affects the extraction rate and flavor of the coffee. In the present configuration, the suitable grind size may be defined based on preference of the user, which may be set using the interactive display screen 120.

At step 914, the method 900 includes pouring or transferring the ground coffee into the coffee brew chamber 170. That is, after grinding, the ground coffee is placed into the coffee brew chamber 170, where the actual brewing process takes place. This process may be facilitated by the user, by first detaching the coffee bean grinder 150 from the base stand 110, and then pouring the ground coffee therefrom into the coffee brew chamber 170. At step 916, the method 900 includes adding water to the coffee brew chamber 170. Herein, the user may pour the water into the coffee brew chamber 170, to allow for the brewing process to take place. It may be appreciated that the water may be added to the coffee brew chamber 170 before or after pouring of the ground coffee therein. It may be appreciated that the quantity of the water added may influence the extraction process and, consequently, the taste of the coffee. At step 918, the method 900 includes heating the ground coffee and water in the coffee brew chamber 170 to a temperature for a time sufficient to make the coffee. For this purpose, the coffee brewing system 100 engages the heating base 172 to heat the mixture of ground coffee and water in the coffee brew chamber 170. This heating process is controlled to reach a temperature and duration sufficient to extract the flavors and aromas from the coffee grounds effectively.

In an embodiment, roasting the coffee beans of the raw state comprises simultaneously heating the electric heat system 136 and rotating the helical mixing blades 134. The electric heat system provides heat energy to transform the raw coffee beans into their roasted state. As the beans are being heated, the helical mixing blades 134 rotate, ensuring that the beans are continuously agitated and evenly exposed to the heat. This simultaneous action of heating and rotating prevent burning and achieve a uniform roast, directly impacting the roasted coffee beans. The sensor 138 also prevents burning to achieve a uniform roast of the coffee beans.

In an embodiment, heating the coffee and water occurs for 5 to 30 minutes, preferably 7 to 20 minutes, and preferably 10 to 15 minutes. That is, the step for brewing the coffee involving the heating of the ground coffee and water in the coffee brew chamber 170 is carefully managed. The coffee brewing system 100 is designed to heat this mixture for a period ranging from 5 to 30 minutes, preferably 7 to 20 minutes, and preferably 10 to 15 minutes. This duration is adjustable depending on the desired strength and flavor concentration of the coffee. The flexibility in the heating time allows for a wide variety of coffee types to be brewed, from light to stronger flavors, to cater to diverse preferences and achieving consistency in quality with each brew.

In the present embodiments, the method 900 of brewing coffee is a Saudi Arabian method of brewing coffee. That is, the method 900 of brewing coffee, using the coffee brewing system 100, is specifically tailored to the traditional Saudi Arabian method of brewing coffee. This method 900 is deeply rooted in the cultural practices and rituals associated with preparing and serving Saudi Arabian coffee. In some embodiments, Saudi Arabian coffee may be prepared with arabica beans or any other coffee beans known in the art. In some embodiments, Saudi Arabian coffee may be prepared with spices such as saffron, cinnamon, cardamom, cloves, the like, and a combination thereof. The spices may be added to the coffee brew chamber 170 before, during, or after the brewing the coffee. The coffee brewing system 100, through its advanced features and precise controls, plays a role in emphasizing these rituals. The coffee brewing system 100 respects and enhances the traditional practices associated with Saudi Arabian coffee preparation, making it possible to replicate the authentic experience in a modern context. This is used in settings where the preparation and serving of coffee is a part of the hospitality and cultural expression, such as in gatherings and social events. The design of the coffee brewing system 100, which can include elements like the dallah 170 used for brewing and serving, adds to the distinctive atmosphere associated with serving Saudi coffee.

The coffee brewing system 100 and the method 900 of the present disclosure offer a more integrated and efficient approach to coffee preparation compared to existing technologies. The coffee brewing system 100 combines roasting, grinding, and brewing in one apparatus, reducing the need for multiple appliances, and streamlining the coffee preparation process. The use of electric heat system 136 for roasting is more environmentally friendly compared to traditional methods involving charcoal, reducing the carbon footprint of coffee preparation. The inclusion of the sensors 138 and 176 ensure that each stage of coffee preparation is executed with precision, resulting in a consistently high-quality product. The interactive display screen 120 allows for adjusting various parameters of brewing coffee, allowing users to tailor the coffee-making process to their preferences. Further, the design of the coffee brewing system 100 emphasizes user convenience, with detachable components for easy cleaning and a compact footprint suitable for home and commercial use. Moreover, the design of the coffee brewing system 100 is both aesthetically pleasing and practical, making it an attractive addition to any kitchen or coffee shop. The coffee brewing system 100 and the method 900 of the present disclosure merge traditional brewing methods with modern technology, offering an authentic yet consistent coffee experience.

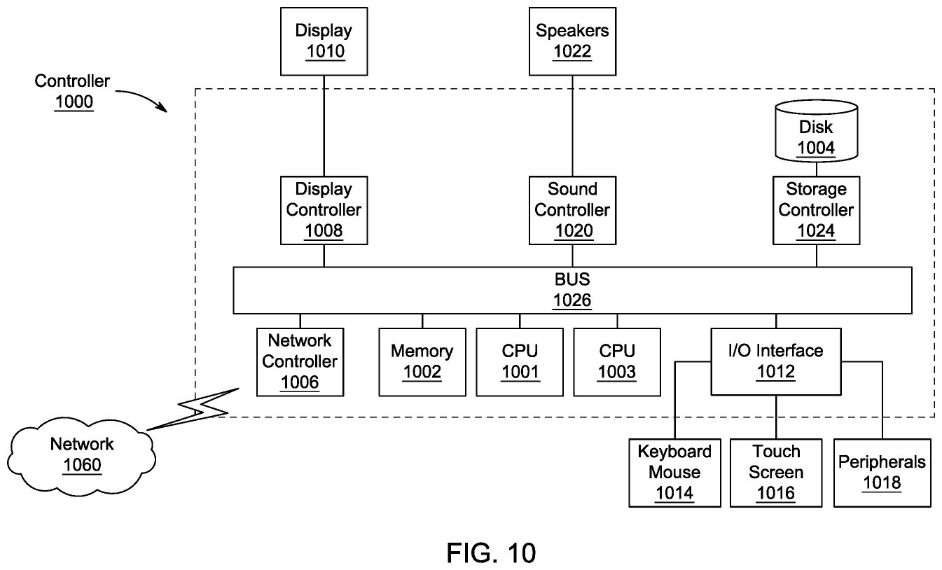

Next, further details of hardware description of control system according to exemplary embodiments is described with reference to FIG. 10. In FIG. 10, a controller 1000 is described as representative of the controller of the coffee brewing system 100 in which the controller is a computing device which includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the process may be controlled by a utility application, background daemon, or component of an operating system, or combination thereof, executing in conjunction with CPU 1001, CPU 1003, and an operating system such as Microsoft Windows 7, Microsoft Windows 10, Microsoft Windows 11, UNIX, Solaris, LINUX, Apple MAC-OS, and other systems known to those skilled in the art.

The hardware elements to achieve the computing device may be realized by various circuitry elements, known to those skilled in the art. For example, CPU 1001 or CPU 1003 may be a Xenon or Core processor from Intel of America, an Opteron processor from AMD of America, or any other processor types that would be recognized by one of ordinary skill in the art. Alternatively, the CPU 1001 and CPU 1003 may be implemented on an FPGA, ASIC, PLD, or using discrete logic circuits, as one of ordinary skill in the art would recognize. Further, CPU 1001 and CPU 1003 may be implemented as multiple processors cooperatively working in parallel to perform the instructions of the inventive processes described above.

The system in FIG. 10 may also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be a wireless network such as a cellular network including EDGE, 3G, 4G, and 5G wireless cellular systems and the like. The wireless network can also be WiFi, Bluetooth, or any other wireless form of communication that is known.

The general purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

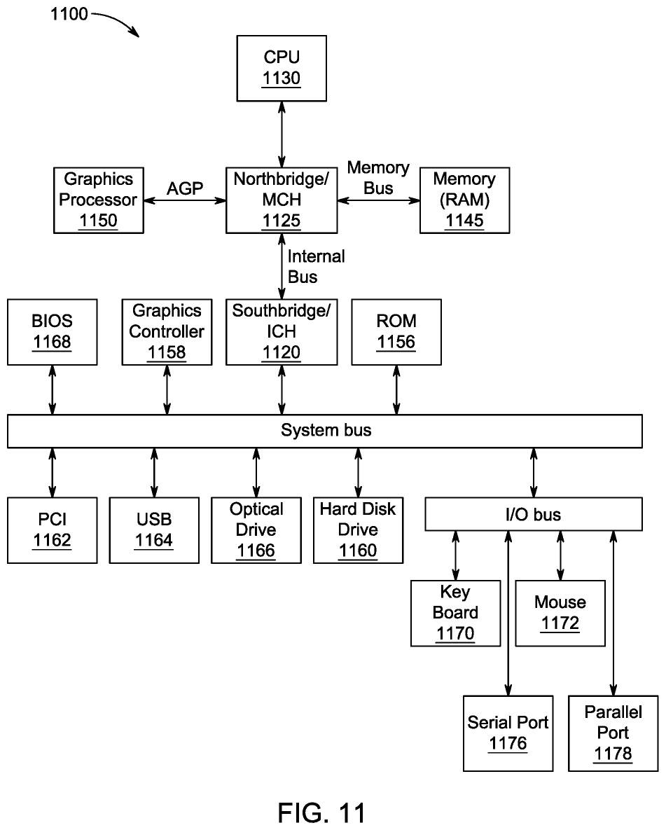

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100, according to certain embodiments, for performing the functions of the exemplary embodiments. The data processing system is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory (RAM) 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU 1130 may contain one or more processors and may even be implemented using one or more heterogeneous processor systems.

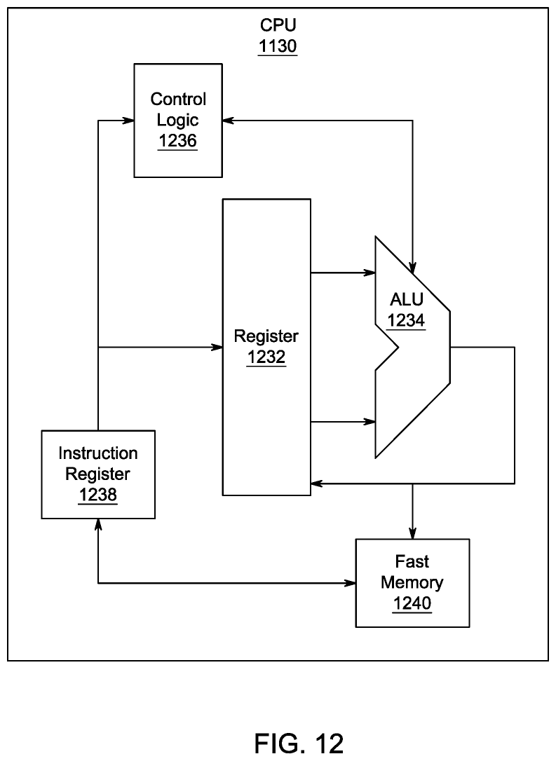

For example, FIG. 12 shows one implementation of CPU 1130. In one implementation, the instruction register 1238 retrieves instructions from the fast memory 1240. At least part of these instructions are fetched from the instruction register 1238 by the control logic 1236 and interpreted according to the instruction set architecture of the CPU 1130. Part of the instructions can also be directed to the register 1232. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a large instruction word architecture, and the like. Furthermore, the CPU 1130 can be based on the Von Neuman model or the Harvard model or any model known in the art. The CPU 1130 can be a digital signal processor, an FPGA, an ASIC, a PLA, a PLD, a CPLD, and the like. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read only memory (ROM) 1156, universal serial bus (USB) port 1164, a flash binary input/output system (BIOS) 1168, and a graphics controller 1158. PCI/PCIe devices can also be coupled to SB/ICH 1120 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

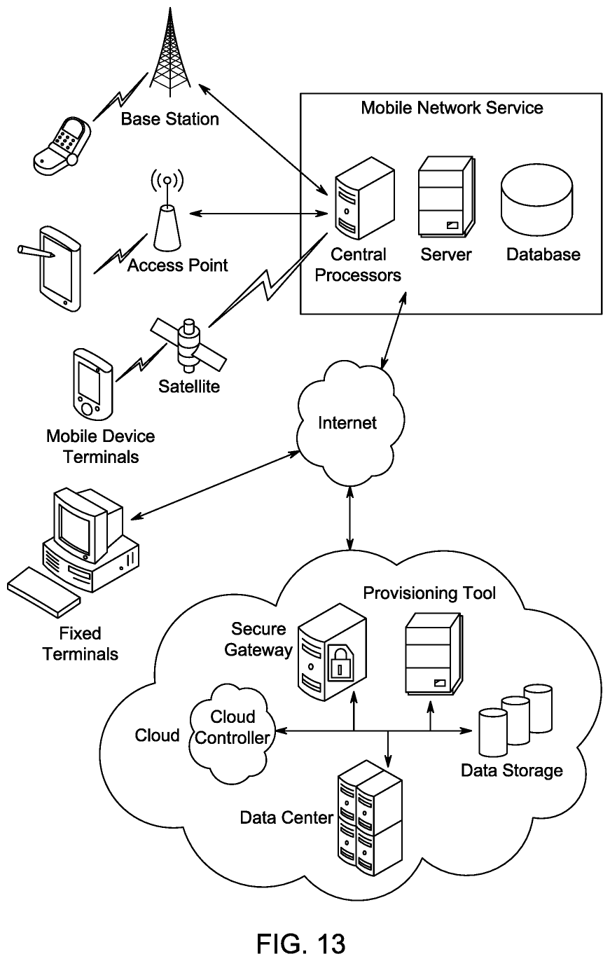

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 13, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the present disclosure may be practiced otherwise than as specifically described herein.

1: A coffee brewing system, comprising:
a base stand having a flat horizontal section, a vertical section circumferentially connected to an edge of the flat horizontal section,
an interactive display screen integral with the base stand,
a coffee bean roaster mounted on the vertical section of the base stand,
wherein the coffee bean roaster is a horizontally mounted cylinder with helical mixing blades,
wherein the coffee bean roaster has an electric heat system on a lower surface and a flap on a front surface,
wherein the coffee bean roaster is detachably mounted on the vertical section of the base stand,
a coffee bean grinder,
wherein the coffee bean grinder is a vertically orientated burr grinder detachably mounted on the flat horizontal section of the base stand,
wherein the coffee bean grinder is positioned below the flap on the front surface of the coffee bean roaster and configured to receive roasted coffee beans exiting the flap of the coffee bean roaster, and
a coffee brew chamber,
wherein the coffee brew chamber is detachably mounted to a heating base integral with the flat horizontal section of the base stand.

2: The coffee brewing system of claim 1, wherein the coffee brew chamber is a dallah.

3: The coffee brewing system of claim 2, wherein the dallah is made of copper.

4: The coffee brewing system of claim 1, wherein the coffee bean roaster has a sensor.

5: The coffee brewing system of claim 4, wherein the sensor is a temperature sensor.

6: The coffee brewing system of claim 5, wherein the temperature sensor detects the temperature inside the coffee bean roaster and is connected with the electric heat system and configured to prevent coffee beans from being burned during roasting.

7: The coffee brewing system of claim 1, wherein the coffee brew chamber has a sensor.

8: The coffee brewing system of claim 7, wherein the sensor is an overflow sensor.

9: The coffee brewing system of claim 8, wherein the overflow sensor detects a liquid in the coffee brew chamber and is connected with the heating base and configured to prevent the liquid from spilling from the coffee brew chamber during brewing.

10: The coffee brewing system of claim 1, wherein the helical mixing blades are connected to a motor configured to rotate the helical mixing blades along a central axis.

11: The coffee brewing system of claim 1, wherein the horizontally mounted cylinder is made of a glass.

12: The coffee brewing system of claim 1, wherein the coffee bean grinder is made of copper.

13: The coffee brewing system of claim 1, wherein the heating base comprises a resistive heating element configured to operate at a temperature of 20 to 120° C.

14: The coffee brewing system of claim 1, wherein the flap on the front surface of the coffee bean roaster has a handle.

15: The coffee brewing system of claim 1, wherein the flat horizontal section of the base stand is circular, and the vertical section of the base stand has a front side and a rear side, wherein the front side is lower than the rear side.

16: The coffee brewing system of claim 15, wherein the interactive display screen is on the vertical section of the base stand on the front side.

17: A method of brewing coffee, comprising:
adding raw coffee beans into the coffee bean roaster of the coffee brewing system of claim 1;
selecting a brew method from the interactive display screen;
roasting the raw coffee beans to form roasted coffee beans,
dropping the roasted coffee beans into the coffee bean grinder;
grinding the roasted coffee beans to form ground roasted coffee beans;
transferring the ground roasted coffee beans into the coffee brew chamber;
adding water to the coffee brew chamber; and
heating the ground roasted coffee beans and water in the coffee brew chamber to a temperature for a time sufficient to make the coffee.

18: The method of claim 17, wherein roasting the raw coffee beans comprises simultaneously heating the electric heat system and rotating the helical mixing blades.

19: The method of claim 17, wherein heating the ground roasted coffee beans and water occurs for 5 to 30 minutes.

20: The method of claim 17, wherein the method of brewing coffee is a Saudi Arabian method of brewing coffee.
